(19) United States
(12) Patent Application Publication
(10) Pub. No.: US 2008/0270879 A1
(43) Pub. Date: Oct. 30, 2008

(54) COMPUTER-READABLE MEDIUM, DOCUMENT PROCESSING APPARATUS AND DOCUMENT PROCESSING SYSTEM

(75) Inventor: Yutaka Komatsu, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/060,538

(22) Filed: Apr. 1, 2008

(30) Foreign Application Priority Data
Apr. 27, 2007 (JP) 2007-118957

(51) Int. Cl. G06F 17/00

(52) U.S. Cl. 715/200

(57) ABSTRACT

A computer-readable medium stores a program causing a computer to execute document processing. The document processing includes: acquiring document data including one or more pieces of attribute information; and acquiring attribute extraction information of each attribute information. Each attribute extraction information includes (i) extraction method information indicating an extraction method for extracting the corresponding attribute information from the document data, and (ii) position information that indicates a position of the corresponding attribute information in the document data, and corresponds to the extraction method indicated by the extraction method information for the corresponding attribute information. The document processing further includes registering attribute information that is extracted from the document data based on the attribute extraction information, as the attribute information of the document data.

### CROSS-REFERENCE TO RELATED APPLICATIONS

This application is based on and claims priority under 35 U.S.C. §119 from Japanese Patent Application No. 2007-118957 filed Apr. 27, 2007.

### BACKGROUND

### Technical Field

The invention relates to a computer-readable medium storing a document processing program, a document processing apparatus and a document processing system.

### SUMMARY

According to an aspect of the invention, a computer-readable medium stores a program causing a computer to execute document processing. The document processing includes: acquiring document data including one or more pieces of attribute information; and acquiring attribute extraction information of each attribute information. Each attribute extraction information includes (i) extraction method information indicating an extraction method for extracting the corresponding attribute information from the document data, and (ii) position information that indicates a position of the corresponding attribute information in the document data, and corresponds to the extraction method indicated by the extraction method information for the corresponding attribute information. The document processing further includes registering attribute information that is extracted from the document data based on the attribute extraction information, as the attribute information of the document data.

### BRIEF DESCRIPTION OF THE DRAWINGS

Exemplary embodiments of the invention will be described in detail below with reference to the accompanying drawings, wherein:

FIG. 1 is an overall view showing the schematic configuration of a document processing system according to a first exemplary embodiment of the invention;

FIG. 2 is a block diagram showing an example of the schematic configuration of a document processing server according to the first exemplary embodiment of the invention;

FIG. 3 is a table showing an example of extraction methods and position information which correspond to first to fourth attribute extraction programs according to the first exemplary embodiment of the invention;

FIG. 4 illustrates an example of an attribute instruction sheet according to the first exemplary embodiment of the invention;

FIG. 5 illustrates an example of a document according to the first exemplary embodiment of the invention;

FIG. 6 illustrates an example in which a document according to the first exemplary embodiment of the invention is marked with an invisible pen;

FIG. 7 illustrates an example in which attribute names and area designation are written in the attribute instruction sheet according to the first exemplary embodiment of the invention;

FIG. 8 is a flowchart showing an operation example of the document processing server according to the first exemplary embodiment of the invention;

FIG. 9 is an overall view showing the schematic configuration of a document processing system according to a second exemplary embodiment of the invention;

FIG. 10 illustrates an example of an attribute-instruction-sheet input screen that is displayed on a display unit of a terminal according to the second exemplary embodiment of the invention;

FIG. 11 is an overall view showing the schematic configuration of a document processing system according to a third exemplary embodiment of the invention;

FIG. 12 is an overall view showing the schematic configuration of a document processing system according to a fourth exemplary embodiment of the invention; and

FIG. 13 is a block diagram showing an example of the schematic configuration of a multifunction device according to the fourth exemplary embodiment of the invention.

### DETAILED DESCRIPTION

### First Exemplary Embodiment

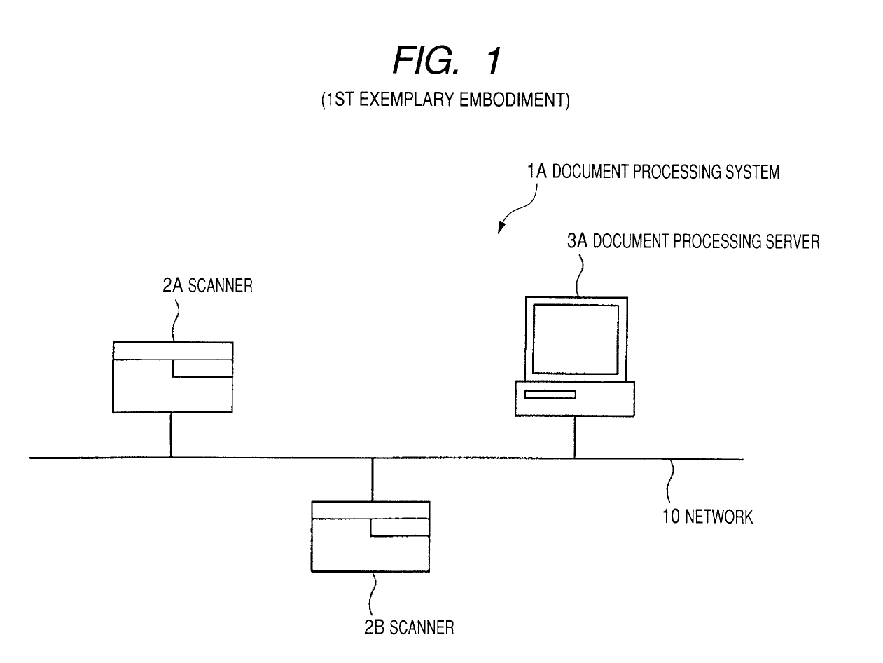

FIG. 1 is an overall view schematically showing the configuration of a document processing system according to a first exemplary embodiment of the invention. This document processing system 1A includes scanners (document reading devices) 2A, 2B each for optically reading a document including attribute information and an attribute instruction sheet that is used to extract the attribute information from the document, and a document processing server (document processing apparatus) 3A for registering, from the scanners 2A, 2B via a network 10, the attribute information included in the document data as attribute information of the document data.

The “attribute information” included in a document means information for classifying a plurality of documents and easily retrieving a specific document from the plurality of documents. For example, the attribute information may be date, place, person's name and the like. Also, one document may include plural pieces of attribute information. Appellations, such as ‘date,’ ‘place,’ and ‘person's name’, which are used to distinguish the respective attribute information from each other, may be called “attribute names”. For example, if “Mar. 1, 2007” is written in a document, the date “Mar. 1, 2007” is the attribute information corresponding to the attribute name “date” of the document. Furthermore, contents of a “document” may be desired one. That is, a document may include, for example, any of a deed of contract, specifications, drawings, tables, illustrations and pictures.

In the attribute instruction sheet, described is attribute extraction information each for extracting corresponding attribute information from a document. Each “attribute extraction information” includes (i) extraction method information indicating an extraction method for extracting corresponding attribute information from document data, and (ii) position information that indicates a position of the corresponding attribute information in the document data and corresponds to the extraction method indicated by the extraction method information for the corresponding attribute information. The extraction method may be selected from a plurality of methods, and in such a case, the attribute extraction information may include selection information that indicates one extraction method selected among the plurality of methods.

The “extraction method” is to designate a method to specify a position where attribute information is written in a document. For example, the extraction method may be a coordinate designation method that specifies an rectangular area containing attribute information using (i) X and Y coordinates of the upper left point of the rectangle with the upper left point of the document being defined as the origin point, and (ii) a width and a height indicating the X-direction length and the Y-direction length each starting from the upper left point of the rectangle.

Further, the “position information” corresponding to the extraction method is information that designates a position, an area, a page and the like where the attribute information included in a document is written in the document. In the case of the coordinate designation method described above, the X and Y coordinates, the width and the height correspond to the position information.

The network 10 is a local area network such as wired LAN and/or wireless LAN. It may also be a network connected to the Internet.

Each of the scanners 2A, 2B includes a reading unit that optically reads originals of documents and attribute instruction sheets as image data using a photoelectric converting device, and a transmitting unit that transmits the image data to the document processing server 3A via the network 10. Although FIG. 1 shows the two scanners 2A, 2B, the number of scanners may be one or more than two.

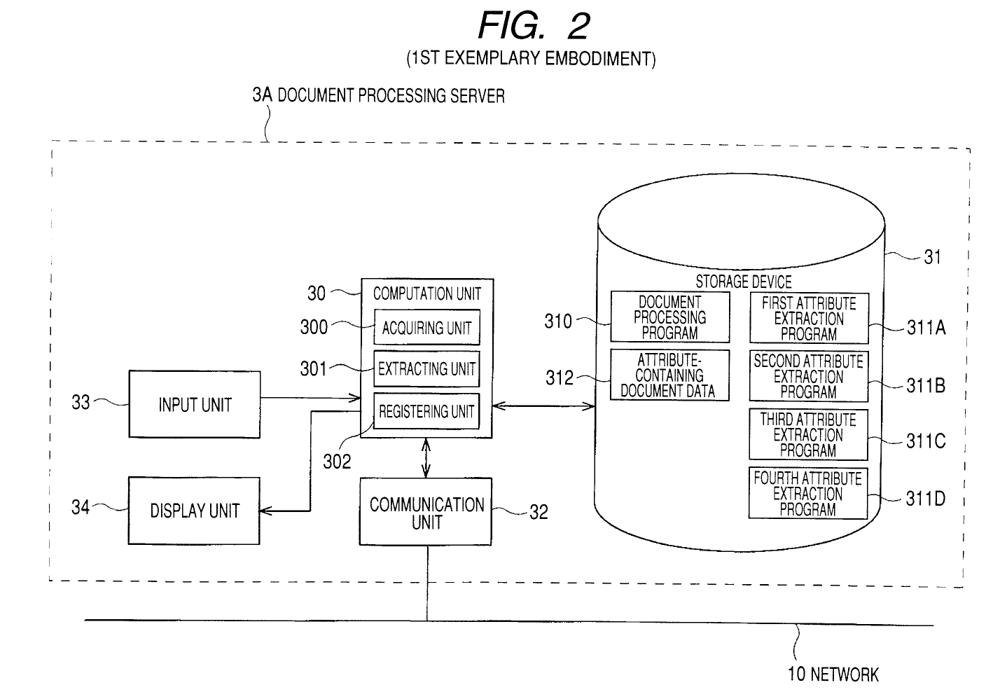

FIG. 2 is a block diagram showing one example of the schematic configuration of the document processing server 3A. This document processing server 3A includes: an computing unit 30, for example, having CPU that controls respective elements of the document processing server 3A; a storage device 31, for example, having ROM, RAM and/or HDD for storing various types of programs such as a document processing program 310 and first to fourth attribute extraction programs 311A to 311D as well as various types of data such as attribute-containing document data 312 attached with attribute information as an attribute of document data; a communication unit (receiving unit) 32, for example, having a network interface card (NIC) for receiving the document data and attribute-instruction-sheet data as image data from the scanners 2A, 2B via the network 10; an input unit 33, for example, having a keyboard for accepting data input, operation and commands as well as a mouse; and a display unit 34, for example, having LCD (liquid display) for displaying thereon process results by the computing unit 30, document data stored in the storage device 31 and the like. The configuration of the document processing server 3 is not limited to a server, but may be implemented by a personal computer (PC) or a work station (WS), for example.

The computing unit 30 functions as an acquiring unit 300, an extracting unit 301 and a registering unit 302 by executing operation in accordance with the document processing program 310 and the first to fourth attribute extraction programs 311A to 311D, which are stored in the storage device 31.

The acquiring unit 300 acquires document data including attribute information from the scanners 2A, 2B, receives attribute-instruction-sheet data including attribute extraction information for extracting attribute information from the document data. The acquiring unit 300 executes a character recognition process so as to acquire, from the attribute-instruction-sheet data, the attribute extraction information for extracting the attribute information. The character recognition process includes: extracting a character pattern in an area that is determined in advance, based on the attribute-instruction-sheet data; comparing the character pattern with a character recognition dictionary by a pattern matching method or the like; and determining one having the highest similarity as recognition result.

The extracting unit 301 selects, from among the first to fourth attribute extraction programs 311A to 311D, an attribute extraction program corresponding to the extraction method included in the attribute extraction information acquired by the acquiring unit 300. The extracting unit 301 extracts attribute information from the document data by sending document data and position information to the selected attribute extraction program and receiving an attribute extraction result obtained by the attribute extraction program.

The registering unit 302 generates the attribute-containing document data 312 to which the attribute information extracted by the extracting unit 301 from the document data is attached as attribute information of the document data, and registers the generated attribute-containing document data 312 in the storage device 31. The registering unit 302 may register the document data and the extracted attribute information, in association with each other, in a database which manages plural pieces of document data. The registering unit 302 may register, in the storage device 31, the attribute-containing document data 312 in a certain file format that application software such as word-processing software can edit.

The first to fourth attribute extraction programs 311A to 311D are programs to extract attribute information by receiving document data and position information via the extracting unit 301 and by executing the character recognition for the document data based on the position information.

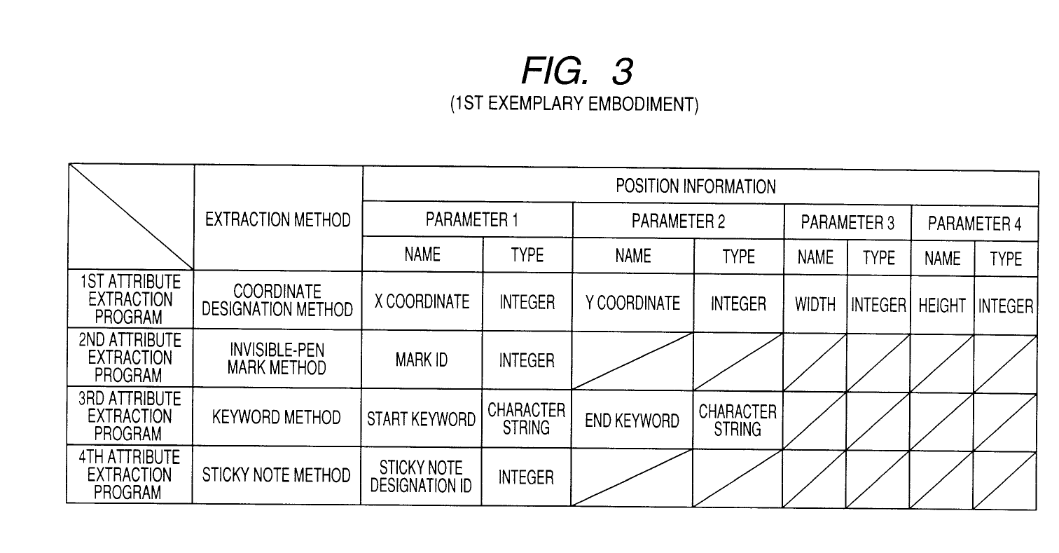

FIG. 3 is a diagram showing an example of extraction methods and position information for the first to fourth attribute extraction programs 311A to 311D.

The first attribute extraction program 311A is a program to execute the character recognition for an area that is in a document and that is designated by the coordinate designation method, that is, an area designated by the four parameters, i.e. X coordinate, Y coordinate, width and height.

The second attribute extraction program 311B is a program to implement an invisible-pen mark method for executing character recognition for an area that is in a document and that is marked with an invisible pen which is invisible to human's eyes but appears in image data read by the scanners 2A, 2B. The marking may be made to surround a character string to be extracted, underline the character string to be extracted, or trace the character string to be extracted. It should be noted that the marking is not limited to these examples.

The third attribute extraction program 311C is a program to execute character recognition process for an area that is sandwiched between (i) a start keyword representing a separator provided at the head of a character string to be extracted, such as (, ┌, {, and (ii) an end keyword representing a separator provided at the end of the character string to be extracted, such as ), ┘, }. Each of the start keyword and the end keyword may be a character string of two or more characters.

The fourth attribute extraction program 311D is a program to extract a page, to which a sticky note is attached, from a document having a plurality of pages, according to whether or not the page has a protruding part (a part corresponding to the attached sticky note), and to execute character recognition process for the entire extracted page. Position information is designated by a sticky-note ID indicating the number of attached sticky notes.

The attribute extraction program is not limited to the four programs. The attribute extraction program may be another attribute extraction program employing another extraction method, or may be selected from among more than four attribute extraction programs. Furthermore, the attribute extraction program may also be selected from two or three attribute extraction programs.

### Operation of First Exemplary Embodiment

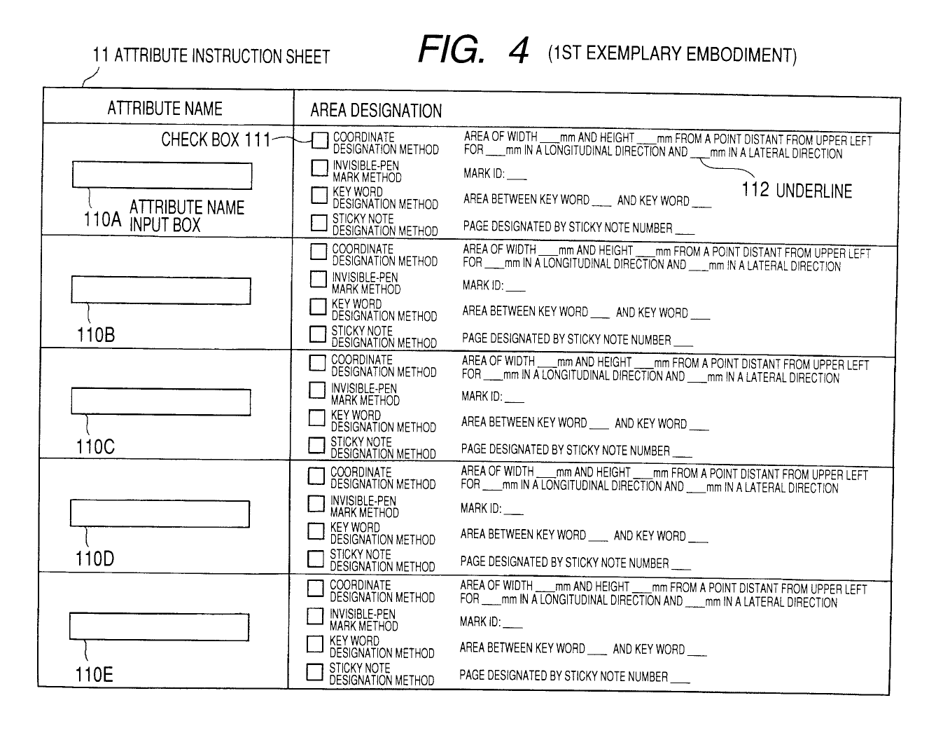

Next, an example of the operation of the document processing system 1A according to the first exemplary embodiment will be described with reference to FIGS. 4 to 8.

FIG. 4 shows an example of the attribute instruction sheet including the attribute extraction information. The attribute instruction sheet 11 shown in FIG. 4 is an instruction sheet for designating positions indicating respective pieces of attribute information in a document. The position information is designated for each of plural attribute names.

The attribute instruction sheet 11 includes: a plurality of attribute name entry boxes 110A to 110E for in which the plurality of attribute names are entered; check boxes 111 used to indicate an extraction method selected from among the four extraction methods, that is, the coordinate designation method, the invisible-pen mark method, the keyword designation method and the sticky note designation method, for designating position information indicating attribute information corresponding to the attribute name entered in the attribute name entry boxes 110A to 110E; and a plurality of underlines 112 in which the position information corresponding to the selected extraction method is written.

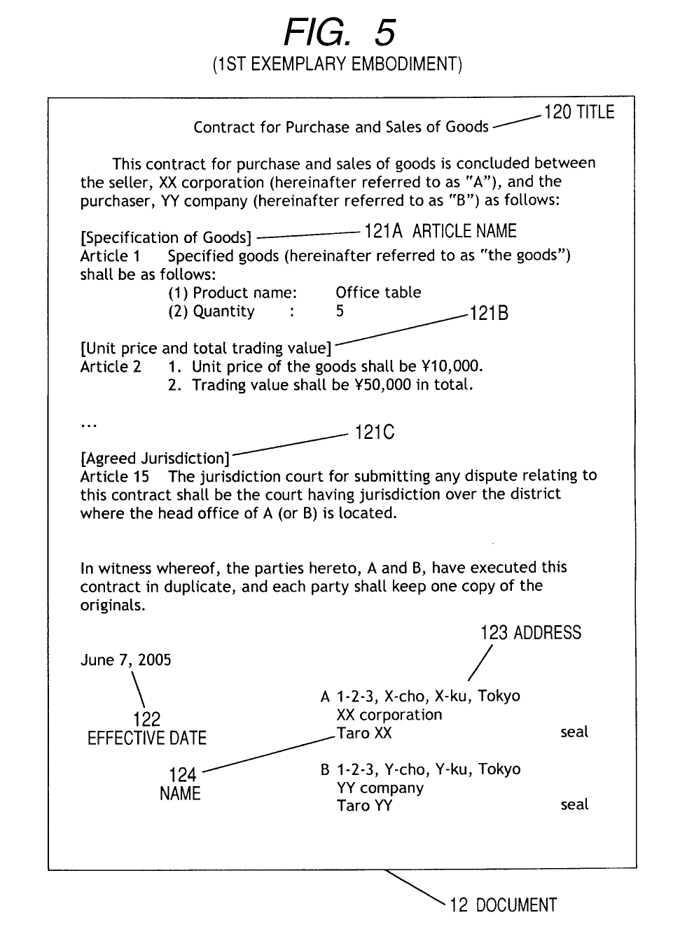

FIG. 5 shows one example of a document that includes attribute information. A document 12 shown in FIG. 5 is a deed of contract regarding sale of goods between companies, that is prepared in accordance with a prescribed format.

The document 12 includes a title 120 of the document, a plurality of articles 121A to 121C relating to this contract, effective date 122 of this contract, and address 123 and name 124 of a seller defined as A in the contract.

An explanation will be given about the case where the title 120, the articles 121A to 121C, the effective date 122, the A's address 123 and the A's name 124 are extracted as attribute information of the document 12, and these pieces of extracted attribute information are registered as the attribute information of the document. The number of pieces of attribute information may be one or plural.

### (1) Entry in Attribute Instruction Sheet

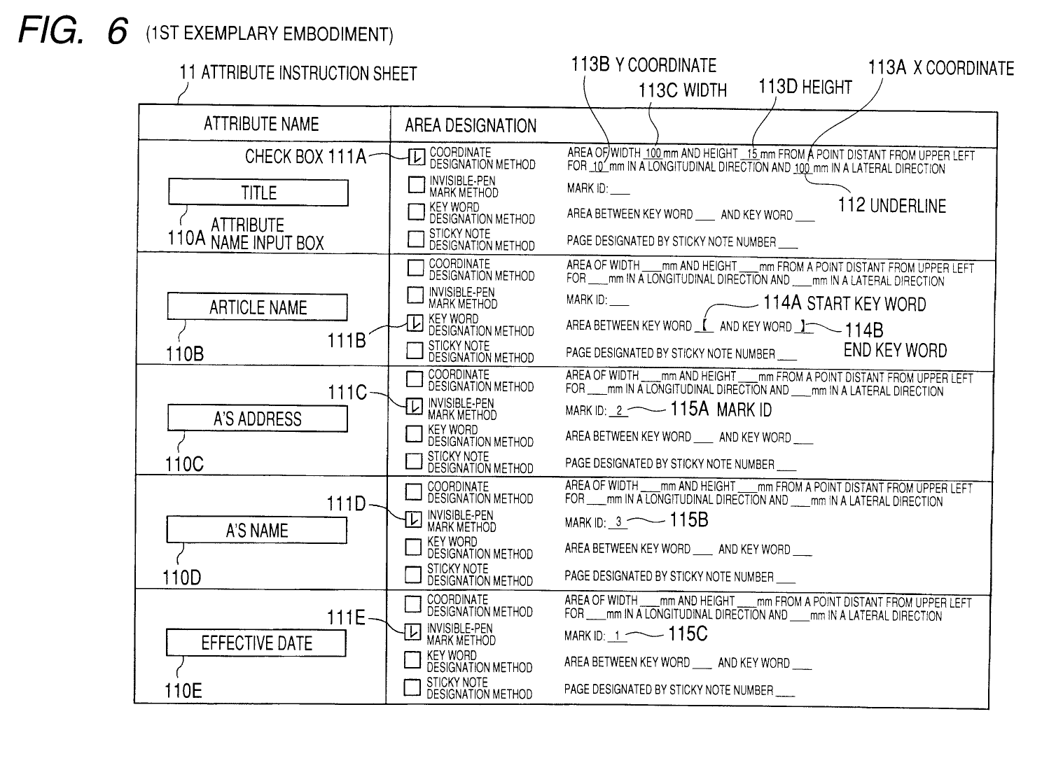

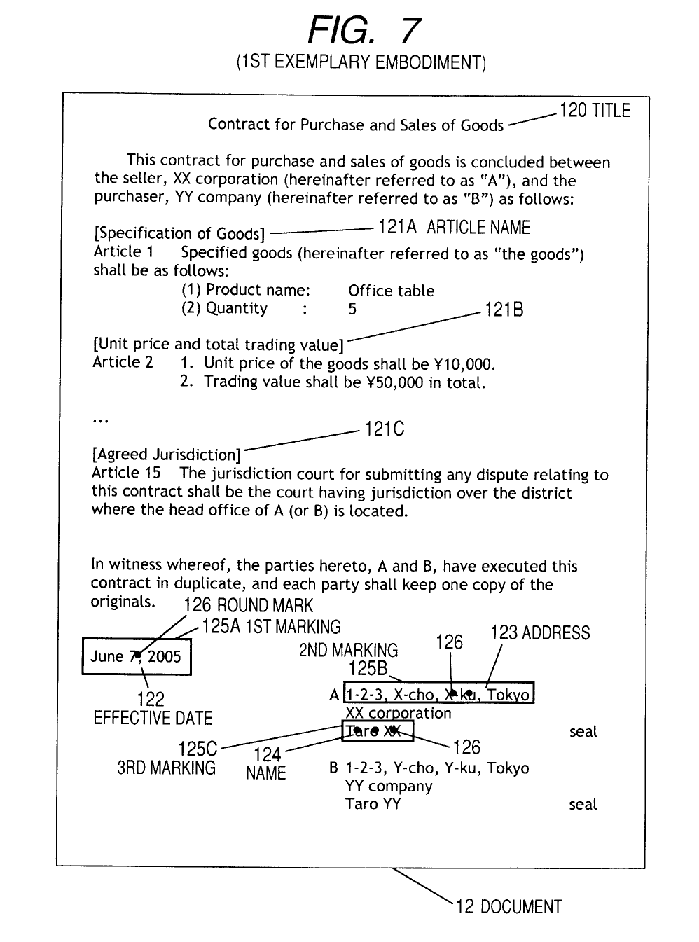

FIG. 6 shows an example of the attribute instruction sheet 11 in which the attribute name boxes and the area designation boxes are filled out. Also, FIG. 7 shows an example of the document 12 in which makings have been made with the invisible pen.

First, a user writes necessary items in the attribute instruction sheet 11. Namely, in order to extract the title 120 as attribute information, the user writes “title” in the attribute name entry box 110A of the attribute instruction sheet 11 as shown in FIG. 6. Then, in order to designate a position in which the “title” is written in the document 12, the user checks the check box 111A of the coordinate designation method, and writes the X coordinate 113A, the Y coordinate 113B, the width 113C and the height 113D on the respective underlines 112 corresponding to the coordinate designation method as the position information. The extraction method may be selected so that the user easily designates the position information in accordance with the format of the document 12.

Next, in order to extract the article names 121A to 121C as attribute information, the user writes “article name” in the attribute entry box 110B of the attribute instruction sheet as shown in FIG. 6. In order to designate positions in which the “article name” in the document 12, the user checks the check box 111B of the keyword designation method, and writes, as position information, the start keyword 114A and the end keyword 114B, for example, “brackets,” on the underlines 112 corresponding to the keyword designation method.

Next, in order to extract the effective date 122, A's address 123 and A's name 124 as attribute information, the user writes “effective date”, “A's name” and “A's address,” respectively, in the attribute name entry boxes 110E, 110C and 110D of the attribute instruction sheet as shown in FIG. 6. Also, in order to designate positions in which the “A's address”, “A's name” and “effective date” are written in the document 12, the user checks the check boxes 111C to 111E of the invisible-pen mark method, and writes “2,” “3,” and “1,” respectively for mark IDs 115A to 115C on the underlines 112 corresponding to the invisible-pen mark method.

Furthermore, as shown in FIG. 7, the user surrounds, with the invisible pen, an area of the document 12 in which the effective date 122 is written. Also, the user enters a round mark 126 with the invisible pen within the surrounding frame (first marking 125A). Similarly, using an invisible pen, the user surrounds areas in which the A's address 123 and the A's name 124 are written, and enters two round marks 126 within the surrounding frame of the former (second marking 125B) and three round marks 126 within the surrounding frame of the latter (third marking 125C), respectively.

Here, the values entered in the mark IDs 115A to 115C of the attribute instruction sheet shown in FIG. 6 are associated with the number of round marks 126 entered in the first to third markings 125A to 125C of the document 12 shown in FIG. 7 so that the positions in which the attribute information corresponding to the attribute names entered in the attribute instruction sheet 11 can be designated in the document 12. The markings made with the invisible pen are not limited to the round marks 126, but may take any shape such as a square, a triangle or a character to designate the positions.

### (2) Attribute Instruction Sheet and Reading of Document

Next, the user reads the completed attribute instruction sheet 11 and the document 12 shown in FIGS. 6 and 7 with the scanners 2A, 2B. In this exemplary embodiment, it is assumed that the scanner 2A is used for the reading. The number of sheets of the document 12 corresponding to each attribute instruction sheet 11 is not limited to one, but may be two or more.

The scanner 2A generates attribute-instruction-sheet data and document data which are, for example, formed of bitmap data from the read-out attribute instruction sheet 11 and the read-out document 12. The scanner 2A transmits the document data and the attribute-instruction-sheet data to the document processing server 3A via the network 10.

### (3) Operation of Document Processing Server

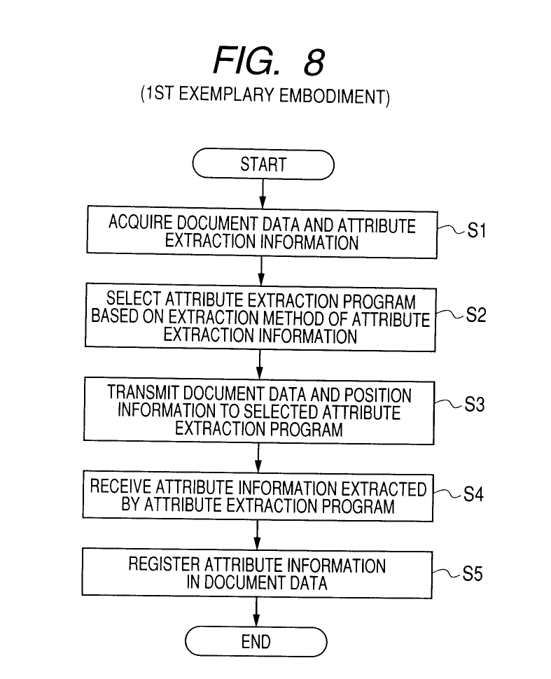

FIG. 8 is a flowchart showing an example of an operation of the document processing server 3A according to this exemplary embodiment.

In the document processing server 3A, upon receiving the document data and the attribute-instruction-sheet data from the scanner 2A, the acquiring unit 300 executes character recognition process for the attribute-instruction-sheet data to acquire attribute extraction information (S1).

Next, the extracting unit 301 selects, from among the attribute extraction programs 311A to 311D, an attribute extraction program that corresponds to an extraction method of the attribute extraction information acquired by the acquiring unit 300 (S2). For example, in the attribute instruction sheet 11 shown in FIG. 6, when the attribute information of the attribute name “title” is extracted, the check box 111A of the coordinate designation method is checked. In this case, therefore, the first attribute extraction program 311A is selected which corresponds to the coordinate designation method as shown in FIG. 3. Also, for the attribute names “A's address”, “B's address” and “effective date”, the second attribute extraction program 311B is selected which corresponds to the invisible-pen mark method. Also, for the attribute name “article name”, the third attribute extraction program 311C is selected which corresponds to the keyword designation method.

Next, the document data and position information are transmitted to the selected attribute extraction programs (S3). For example, integers of the X coordinate 113A, the Y coordinate 113B, the width 113C and the height 113D, which are written in the attribute instruction sheet 11, are transmitted as the position information to the first attribute extraction program 311A, which correspond the attribute name “title”. The document data 12 in which the first and third markings 125A to 125C and the round marks 126 are written is transmitted as the position information to the second attribute extraction program 311B, which corresponds to the attribute names “A's address”, “B's address” and “contract completion date”. Furthermore, the character strings of the start keyword 114A and the end keyword 114B, which are written in the attribute instruction sheet 11, are transmitted as the position information to the third attribute extraction program 311C, which correspond to the attribute name “article name”.

The selected first to third attribute extraction programs 311A to 311C each operates to extract an area corresponding to the position information from the document data, and executes the character recognition for the extracted area to extract the attribute information. For example, the first attribute extraction program 311A executes the character recognition for an area of the document data designated by the X coordinate 113A, the Y coordinate 113B, the width 113C and the height 113D, and extracts a character string of “contract of sale of goods”. The second attribute extraction program 311B extracts areas in which the respective first to third markings 125A to 125C are written, and executes the character recognition for the respective extracted areas to extract character stings of “Jun. 7, 2005”, “1-2-3, X-cho, X-ku, Tokyo” and “Taro X” as well as the numbers of round marks 126 for the respective character strings. Also, the third attribute extraction program 311C searches for an area surrounded by the start keyword 114A and the end keyword 114B, and executes the character recognition for the found area to extract character stings of “designation of goods”, “unit price and total trading value” and “agreed jurisdiction”.

Next, the extracting unit 301 receives the attribute information extracted from the document data by the selected attribute extraction program (S4). For example, the extracting unit receives, from the first attribute extraction program 311A, the character string “contract of sale of goods” as the attribute information of the attribute name “title”. Also, the extracting unit 301 receives, from the second attribute extraction program 311B, the character stings of “Jun. 7, 2005”, “1-2-3, X-cho, X-ku, Tokyo” and “Taro X” as well as the numbers of round marks 126 corresponding to the respective character strings, and renders the these character strings to be the attribute information corresponding to the attribute names “A's address”, “B's address” and “effective date” so that the integers entered as the mark IDs 115A to 115C are identical with the numbers of round marks 126, respectively. Also, the extracting unit 301 receives, from the third attribute extraction program 311C, the character stings “designation of goods”, “unit price and total trading value” and “agreed jurisdiction” as the attribute information of the attribute name “article name”.

Next, the registering unit 302 generates attribute-containing document data 312 to which plural pieces of attribute information extracted from the document data by the extracting unit 301 are added as attributes of the document data. For example, the registering unit 302 adds, to the document data, (i) the attribute information “contract of sale of goods” for the attribute name “title”, (ii) the attribute information “Taro X” for the attribute name “name”, (iii) the attribute information “1-2-3, X-cho, X-ku, Tokyo” for the attribute name “A's address”, (iv) the attribute information “Jun. 7, 2005” for the attribute name “effective date”, and (v) the attribute information “designation of goods”, “unit price and total trading value” and “agreed jurisdiction” for the attribute name “article name”. Then, the registering unit 302 registers the generated attribute-containing document data 312 in the storage device 31 (S5).

Thereafter, the user inputs, via the input unit 33 of the document processing server 3A, attribute information or an attribute name and a search key for the attribute name, for example, attribute information corresponding to he attribute name, and browses the attribute-containing document data 312 corresponding to the search key via the display unit 34.

### Second Exemplary Embodiment

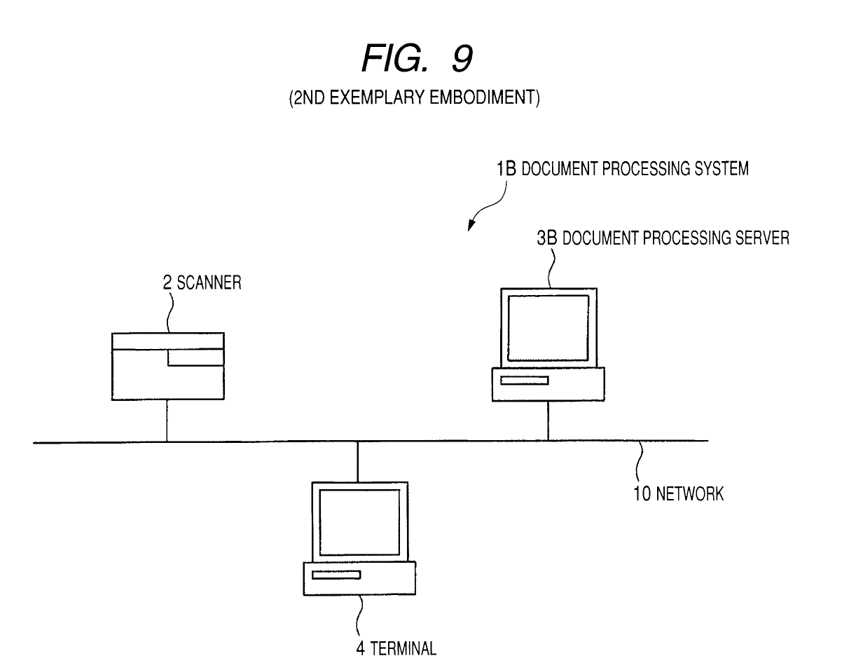

FIG. 9 is an overall view schematically showing the configuration of a document processing system according to a second exemplary embodiment of the invention. In the first exemplary embodiment, the attribute extraction information is input using the attribute instruction sheet, whereas in this exemplary embodiment, the attribute extraction information is input via the input unit. That is, a document processing system 1B of this exemplary embodiment includes: a scanner (document reading device) 2; a terminal 4 including an input unit having a key board and a mouse, and a display unit having an LCD (liquid crystal display) for displaying an input screen thereon; and a document processing server 3B. Attribute extraction information is input on a screen displayed on the display unit of the terminal 4 via the input unit, and the attribute-containing document data 312 stored in the document processing server (document processing apparatus) 3B is searched and browsed on the screen of the terminal 4.

As compared with the document processing server 3A of the first exemplary embodiment, the document processing server 3B is different in that the acquiring unit 300 receives attribute extraction information from the terminal 4 via the network 10. The remaining configuration is the same.

In addition to the input unit and the display unit, the terminal 4 includes a CPU for controlling the terminal 4; a storage unit having ROM, RAM and/or a hard disk for storing an attribute-extraction-information input program for inputting and editing attribute extraction information, to be executed by the CPU as well as various kinds of data; and a communication unit (for example, a network interface card) connected to the network 10. The terminal 4 is, for example, a personal computer (PC) and a personal digital assistance (PDA).

FIG. 9 shows one scanner 2 and one terminal 4, but each of them may be two or more.

### Operation of Second Exemplary Embodiment

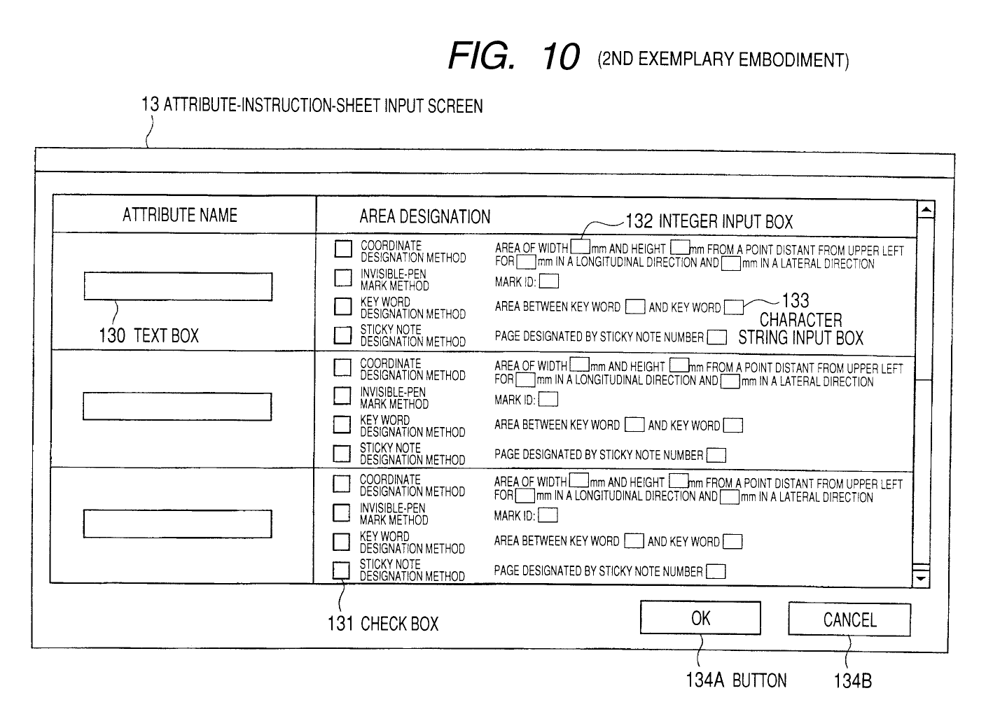

Next, an example of an operation of the document processing system 1B according to the second exemplary embodiment will be described with reference to FIG. 10.

FIG. 10 shows an example of an attribute-instruction-sheet input screen 13 displayed on the display unit of the terminal 4. The attribute-instruction-sheet input screen 13 is a window displayed on the display unit of the terminal 4 by executing the attribute-extraction-information input program by the CPU of the terminal 4.

A user executes the attribute-extraction-information input program by the terminal 4, and displays the attribute-instruction-sheet input screen 13 on the display unit of the terminal 4. Then, the user inputs an attribute name in a text box 130 on the attribute-instruction-sheet input screen 13, designates an extraction method corresponding to the input attribute name by checking a text box 131, and inputs position information corresponding to the extraction method in an integer input box 132 and a character string input box 133.

Next, when the user inputs attribute extraction information and presses an “OK” button 134A, the terminal 4 transmits the input attribute extraction information to the document processing server 3B via the network 10. If the user presses a “cancel” button 134B, the terminal 4 interrupts the input of the attribute extraction information.

Furthermore, when the user reads out with the scanner 2 a document from which attribute information are to be extracted according to the attribute extraction information, the scanner 2 transmits the read document data to the document processing server 3A via the network 10.

The document processing server 3B receives the attribute extraction information from the terminal 4, receives the document data from the scanner 2, and transmits the document data and the attribute extraction information to the acquiring unit 300.

Thereafter, in the same manner as in the first exemplary embodiment, attribute information are extracted, attribute-containing document data 312 is generated, and the generated attribute-containing document data 312 is registered in the storage device 31.

### Third Exemplary Embodiment

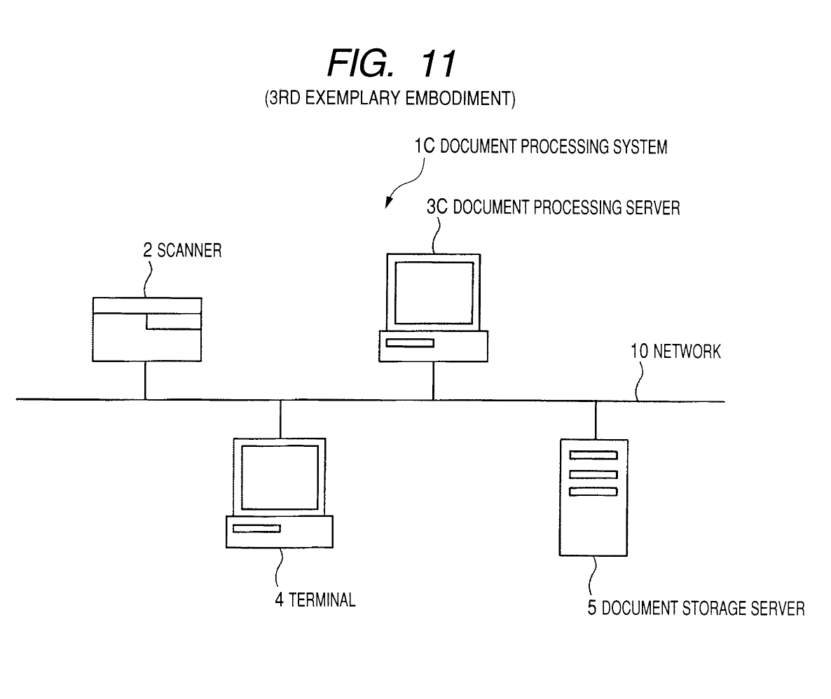

FIG. 11 is an overall view schematically showing the configuration of a document processing system according to a third exemplary embodiment of the invention. In the first and second exemplary embodiments, the attribute-containing document data 312 is registered in the storage device 31 of the document processing server 3A, 3B, whereas in this exemplary embodiment, the attribute-containing document data 312 is registered in a document storage server 5 via the network 10. That is, a document processing system IC of this exemplary embodiment further includes the document storage server 5 that includes: a storage unit having ROM, RAM and/or a hard disk for storing the attribute-containing document data 312; and a communication unit (for example, a network interface card) connected to the network 10.

As compared with the document processing server 3B of the second exemplary embodiment, the document processing server 3C is different only in that the registering unit 302 registers the attribute-containing document data 312 in the storage unit of the document storage server 5 via the network 10. The remaining configuration is the same.

As compared with the terminal 4 of the second exemplary embodiment, the terminal 4 of this exemplary embodiment is different only in that the attribute-containing document data 312 stored in the document storage server 5 is searched and browsed via the network 10. The remaining configuration is the same.

In addition to the memory unit and the communication unit, the storage server 5 includes: a CPU for controlling respective portions of the document storage server 5; an input unit having a key board and a mouse each for accepting data input and operational instructions; and a display unit having an LCD (liquid crystal display) for displaying thereon input screens. The document storage server 5 may be a personal computer (PC), a work station (WS) and the like, in place of a server.

### Fourth Exemplary Embodiment

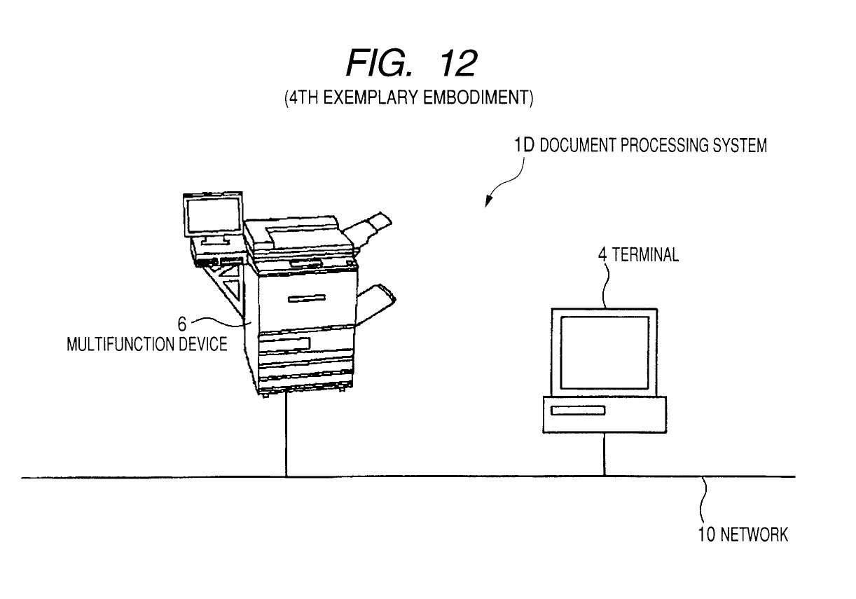

FIG. 12 is an overall view schematically showing the configuration of a document processing system according to a fourth exemplary embodiment of the invention. A document processing system ID includes: a multifunction device (document processing apparatus) 6 for optically reading a document and an attribute instruction sheet and registering attribute information contained in the document as attribute information of document data; and a terminal 4 connected to the multifunction device 6 via the network 10 to search and browse the document data registered in the multifunction device 6.

FIG. 12 shows one multifunction device 6 and one terminal 4, but each of them may be two or more.

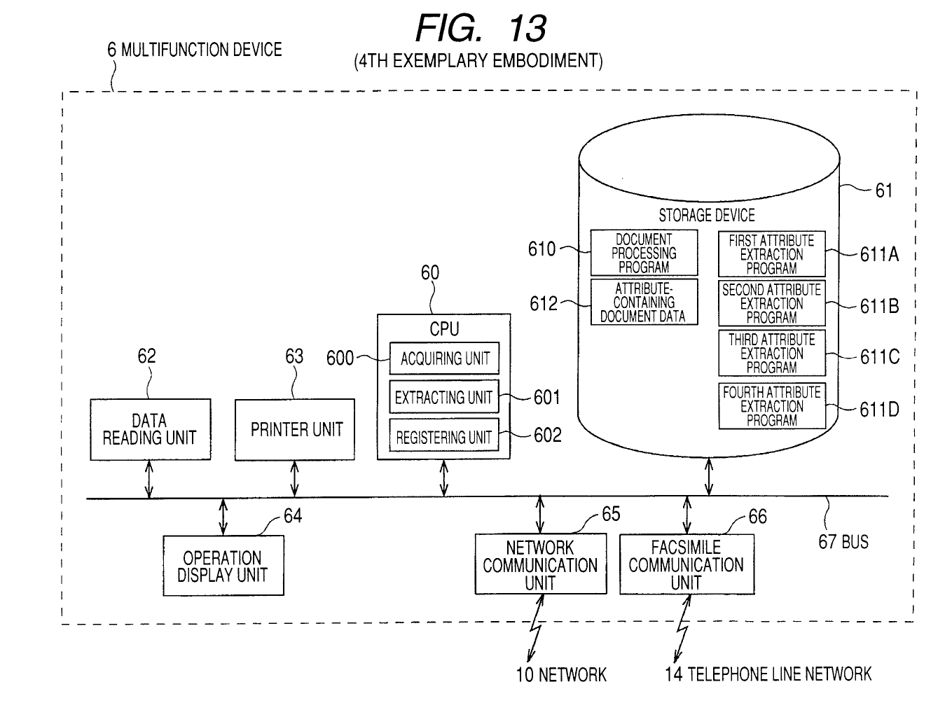

FIG. 13 is an example of a block diagram showing the schematic configuration of the multifunction device 6. This multifunction device 6 includes: a CPU 60 for controlling respective portions of the multifunction device 6, a storage device 61 having ROM, RAM and/or HDD for storing therein various kinds of programs such as a document processing program 610 and first to fourth attribute extraction programs 611A to 611D as well as various kinds of data such as attribute-containing document data 612 that contains attribute information attached as an attribute of the document data; a data reading unit (reading unit) 62 for reading document data and attribute-instruction-sheet data as image data from a document and an attribute instruction sheet by a photoelectric converting device; a printer unit 63 of an electro-photography type or an inkjet type for outputting the document data; an operation display unit (input unit) 64 having a touch-panel display formed by superposing a touch panel on the surface of a display as well as a hard key such as a start key; a network communication unit (for example, network interface card) 65 connected to the network 10; and a facsimile communication unit 66 connected to a telephone line network 14. All these units are mutually connected via a bus 67.

The CPU 60 operates according to the document processing program 610 and the first to fourth attribute extraction programs 611A to 611D, which are stored in the storage device 61, so as to function as an acquiring unit 600, an extracting unit 601 and a registering unit 602 in the same manner as the document processing server 3A in the first exemplary embodiment.

### Operation of Fourth Exemplary Embodiment

Next, a description will be made of an example of an operation of the document processing system 1D according to the fourth exemplary embodiment.

First, a completed attribute instruction sheet 11 and a document 12, which are the same as those in the first exemplary embodiment, are read our by a user with the reading unit 62 of the multifunction device 6. Instead of reading out the completed attribute instruction sheet 11, the user may input attribute extraction information in an attribute designation input screen 13 displayed on the display unit of the terminal 4 or the operation display unit 64 of the multifunction device 6.

The multifunction device 6 transmits, to the acquiring unit 600, the document data and the attribute-instruction-sheet data read out by the data reading unit 62.

Next, the acquiring unit 600 performs the character recognition process for the attribute-instruction-sheet data to acquire attribute extraction information for extracting attribute information from the document data.

Next, the extracting unit 601 selects, from among the first to fourth attribute extraction programs 311A to 311D, an attribute extraction program corresponding to an extraction method designated by the attribute extraction information acquired by the extracting unit 600.

Subsequently, the extracting unit 601 transmits the document data and position information to the selected attribute extraction program, and receives attribute information extracted from the document data by the selected extraction program.

Next, the registering unit 602 generates attribute-containing document data 612 to which the attribute information are attached as attributes of the document data, and registers the generated attribute-containing document data 612 in the storage device 61.

Thereafter, using the attribute information or the attribute name and other attribute information corresponding thereto as a search key, the user searches for document data through the terminal 4, and browses the attribute-containing document data 612 corresponding to the search key. Alternatively, the operation display unit 64 of the multifunction device 6 may be used for search and browsing.

### Other Exemplary Embodiments

The invention is not limited to the foregoing exemplary embodiments, and may be modified without departing from the scope of the invention. For example, in the first to third exemplary embodiments, the document processing servers 3A to 3C receive the document data and the attribute-instruction-sheet data read out by the scanners 2A, 2B via the network 10. However, those exemplary embodiments may receive image data via a telephone line network 14, or may receive a part of image data via the network 10 and then the remaining of the image data via the telephone line network 14.

Furthermore, in each of the foregoing exemplary embodiments, the document processing servers 3A to 3C and the acquiring unit, the extracting unit and the registering unit of the multifunction device 6 are implemented by the computing unit or CPU and the document processing program and the attribute extraction programs. However, a part or all of them may be implemented by hardware such as application specific integrated circuits (ASIC).

The document processing program used in each of the foregoing exemplary embodiments may be read from a storage medium as CD-ROM into the storage unit within the apparatus, or may be downloaded from a server connected to the network like the Internet into the storage unit of the apparatus.

Furthermore, the document processing program used in each of the foregoing exemplary embodiments may include some or all of the first to fourth attribute extraction programs 311A to 311D.

Still further, the component elements of the foregoing exemplary embodiments may be optionally combined without departing from the scope of the invention.

What is claimed is:

1. A computer-readable medium storing a program that causes a computer to execute document processing, the document processing comprising:
acquiring document data including one or more pieces of attribute information;
acquiring attribute extraction information of each attribute information, wherein each attribute extraction information includes
(i) extraction method information indicating an extraction method for extracting the corresponding attribute information from the document data, and
(ii) position information that indicates a position of the corresponding attribute information in the document data, and corresponds to the extraction method indicated by the extraction method information for the corresponding attribute information; and
registering attribute information that is extracted from the document data based on the attribute extraction information, as the attribute information of the document data.

2. The computer-readable medium according to claim 1, wherein when the extraction method is an invisible-pen mark method, the position information includes an image that is drawn with an invisible pen and is included in the document data.

3. The computer-readable medium according to claim 1, wherein the extracted attribute information is registered for each attribute name.

4. The computer-readable medium according to claim 2, wherein the extracted attribute information is registered for each attribute name.

5. The computer-readable medium according to claim 1, wherein the extraction method is a method which is selected from among a plurality of extraction methods, and the attribute extraction information indicates that the extraction method is selected from among the plurality of extraction methods.

6. The computer-readable medium according to claim 2, wherein the extraction method is a method which is selected from among a plurality of extraction methods, and the attribute extraction information indicates that the extraction method is selected from among the plurality of extraction methods.

7. The computer-readable medium according to claim 3, wherein the extraction method is a method which is selected from among a plurality of extraction methods, and the attribute extraction information indicates that the extraction method is selected from among the plurality of extraction methods.

8. The computer-readable medium according to claim 4, wherein the extraction method is a method which is selected from among a plurality of extraction methods, and the attribute extraction information indicates that the extraction method is selected from among the plurality of extraction methods.

9. A document processing apparatus comprising:
an acquiring unit that acquires document data including one or more pieces of attribute information and acquires attribute extraction information of each attribute information, wherein each attribute extraction information includes
(i) extraction method information indicating an extraction method for extracting the corresponding attribute information from the document data, and
(ii) position information that indicates a position of the corresponding attribute information in the document data, and corresponds to the extraction method indicated by the extraction method information for the corresponding attribute information; and
a registering unit that registers attribute information that is extracted from the document data based on the attribute extraction information, as the attribute information of the document data.

10. A document processing apparatus comprising:
a reading unit that reads document data from a document including one or more pieces of attribute information and reads, from an attribute instruction sheet, attribute extraction information of each attribute information, wherein each attribute extraction information includes
(i) extraction method information indicating an extraction method for extracting the corresponding attribute information from the document data, and
(ii) position information that indicates a position of the corresponding attribute information in the document data, and corresponds to the extraction method indicated by the extraction method information for the corresponding attribute information; and
a registering unit that registers attribute information that is extracted from the document data based on the attribute extraction information read by the reading unit, as the attribute information of the document data.

11. A document processing apparatus comprising:
a document reading unit that reads document data from a document including one or more pieces of attribute information;
an input unit that inputs attribute extraction information of each attribute information, wherein each attribute extraction information includes
(i) extraction method information indicating an extraction method for extracting the corresponding attribute information from the document data, and
(ii) position information that indicates a position of the corresponding attribute information in the document data, and corresponds to the extraction method indicated by the extraction method information for the corresponding attribute information; and
a registering unit that registers attribute information that is extracted from the document data read by the reading unit based on the attribute extraction information input by the input unit, as the attribute information of the document data.

12. A document processing system comprising:
a document reading apparatus including
a reading unit that reads document data from a document including one or more pieces of attribute information and reads, from an attribute instruction sheet, attribute extraction information of each attribute information, wherein each attribute extraction information includes
(i) extraction method information indicating an extraction method for extracting the corresponding attribute information from the document data, and
(ii) position information that indicates a position of the corresponding attribute information in the document data, and corresponds to the extraction method indicated by the extraction method information for the corresponding attribute information, and
a transmitting unit that transmits the document data read by the reading unit and the attribute extraction information; and
a document processing apparatus including
a receiving unit that receives the document data and the attribute extraction information, which are transmitted by the transmitting unit,
an extracting unit that extracts attribute information from the document based on the attribute extraction information received by the receiving unit, and
a registering the attribute information extracted by the extracting unit as the attribute information of the document data.
